(19) United States
(12) Patent Application Publication
(10) Pub. No.: US 2010/0235985 A1
(43) Pub. Date: Sep. 23, 2010

(54) Sofa Bed

(76) Inventor: Edele Lee Singer, Laguna Woods, CA (US)

Correspondence Address: IAN F. BURNS & ASSOCIATES, 4790 Caughlin Parkway #701, RENO, NV, 89519-0907, US

(21) Appl. No.: 12/726,970

(22) Filed: Mar. 18, 2010

Related U.S. Application Data
(60) Provisional application No. 61/161,692, filed on Mar. 19, 2009.

(51) Int. Cl. A47C 17/62; B60B 33/00

(52) U.S. Cl. 5/3

(57) ABSTRACT

A sofa bed configured for conversion from a sofa into a double bed. The sofa bed includes a table having a first and second headboard and an interior area. A first frame is connected to the first headboard and a second frame is connected to the second headboard. A pivot member is coupled to the table and to the headboards. The pivot member allows the headboards to rotate relative to the table. An opening is located in the first headboard. A mattress rests on the first frame. The mattress is movable from an extended position located outside the table to a retracted position such that at least a portion of the mattress extends through the opening into the table.

### CROSS REFERENCE TO RELATED APPLICATIONS

This application claims priority to U.S. provisional patent application Ser. No. 61/161,692, filed Mar. 19, 2009. The entire contents of which are herein incorporated by reference.

### FIELD OF THE INVENTION

The present invention relates to a convertible sofa bed that can be placed in a room corner and that can be converted from a sofa into a bed.

### BACKGROUND

Homes and apartments with small room sizes often have difficulty with the placement and arrangement of furniture. Frequently, a room may have one long wall and a short wall. The short wall may prevent the use of various pieces of furniture. Space is at a premium in these residences and it is beneficial if the furniture used is multi-functional. Sofas and beds are two of the larger pieces of household furniture and their combination can save considerable floor space. While convertible sofa beds have been known, they have lacked the ability to be used with short walls and have lacked a headboard when setup in the bed configuration.

### SUMMARY OF ONE EMBODIMENT OF THE INVENTION

### Brief Description of One Embodiment of the Present Invention

In one embodiment, the present invention comprises a furniture assembly that includes a table having a first and second headboard and an interior area. A first frame is connected to the first headboard and a second frame is connected to the second headboard. A pivot member is coupled to the table and to the first and second headboards. The pivot member allows the first and second headboards to rotate relative to the table. A first opening is located in the first headboard. A first mattress is adapted to rest on the first frame. The first mattress is movable from an extended position located outside the interior area to a retracted position such that at least a portion of the first mattress extends through the first opening into the interior area.

In another embodiment, the present invention comprises a furniture assembly that includes a table having a first opening and an interior area. A first pivot member is coupled to the table. A first upper headboard portion is coupled to the pivot member. The first upper headboard portion covers at least a portion of the first opening. A first frame has a first end and a second end. A first lower headboard portion is connected to the first end of the first frame. The first frame and the first lower headboard portion move from a first position outside the table to a second position wherein the first lower headboard portion and at least a portion of the first frame extend through the first opening into the interior area. A second pivot member is coupled to the table and a second headboard is coupled to the second pivot member.

In an additional embodiment, the present invention comprises a furniture assembly that includes a table having a top surface and defining an interior area. A first headboard is coupled to a first side of the table. The first headboard has a first opening. A second headboard is coupled to a second side of the table. The second headboard has a second opening. A first frame is connected to the first headboard. A first connector mechanism is coupled between the first headboard and the table. The first connector mechanism allows the first headboard to be selectively removed from the table.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### ADVANTAGES OF ONE OR MORE EMBODIMENTS OF THE PRESENT INVENTION

The various embodiments of the present invention may, but do not necessarily, achieve one or more of the following advantages:

The ability to use a sofa bed in rooms with shorter walls;

The ability to partially store a mattress within a table;

Provide a table that has removable bed headboards;

Provide a sofa that can be converted into a bed with headboards;

Provide a sofa bed that can be configured into several different sofa and bed combinations;

The ability to move a mattress through an opening in a headboard for storage;

The ability to provide a two piece headboard that can cover a table opening and be moved to form a bed headboard;

Provide a corner table that can convert into a desk;

Provide a u-clip that can hold two platforms or frames together;

Provide a platform or frame that can support backrest cushions without the need for a wall;

Provide a table with a covered storage area that can at least partially store a mattress; and

These and other advantages may be realized by reference to the remaining portions of the specification, claims, and abstract.

### BRIEF DESCRIPTION OF THE DRAWINGS

FIG. 1 is substantially an overall perspective view of a sofa bed in a sofa configuration in accordance with the present invention.

FIG. 2 is substantially a perspective view of the sofa bed of FIG. 1 with the backrests removed.

FIG. 3 is substantially a perspective view of the sofa bed of FIG. 1 in a bed configuration.

FIG. 4 is substantially a perspective view of the sofa bed of FIG. 1 with one of the sofas in a retracted or short configuration.

FIG. 5 is substantially an overall perspective view of the table and frames of the present invention.

FIG. 6 is substantially a perspective view of the table and frames of FIG. 5 with the frames in a bed configuration.

FIG. 7 is substantially an enlarged perspective view of the interior of the table.

FIG. 8 is substantially an enlarged perspective view of the table and headboards of FIG. 1 with one of the headboards rotated away from the table.

FIG. 9 is substantially a cross-sectional view of the backrest of FIG. 1.

FIG. 10 is substantially an overall perspective view of a sofa bed in a sofa configuration with the backrests removed in accordance with another embodiment of the present invention.

FIG. 11 is substantially a perspective view of the sofa bed of FIG. 10 in a bed configuration.

FIG. 12 is substantially a perspective view of the sofa bed of FIG. 10 with one of the sofas in a retracted or short configuration.

FIG. 13 is substantially an enlarged perspective view of the table and headboards of FIG. 10 with one of the headboards rotated away from the table.

FIG. 14 is substantially an overall perspective view of a sofa bed table and frame in accordance with an additional embodiment of the present invention.

FIG. 15 is substantially a perspective view of a headboard and frames removed from the table of FIG. 14.

FIG. 16 is substantially a perspective view of the table of FIG. 14 with the headboard removed.

FIG. 17 is substantially a backside view of the headboard removed from the table of FIG. 14.

FIG. 18 is substantially an overall prospective view of an alternative embodiment of a sofa bed framed and tables for use with a wall less configuration in accordance with the present invention.

FIG. 19 is substantially an enlarged perspective view of the U clips of the present invention showing a pair of frames being retained by the U clips.

### DESCRIPTION OF CERTAIN EMBODIMENTS OF THE PRESENT INVENTION

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

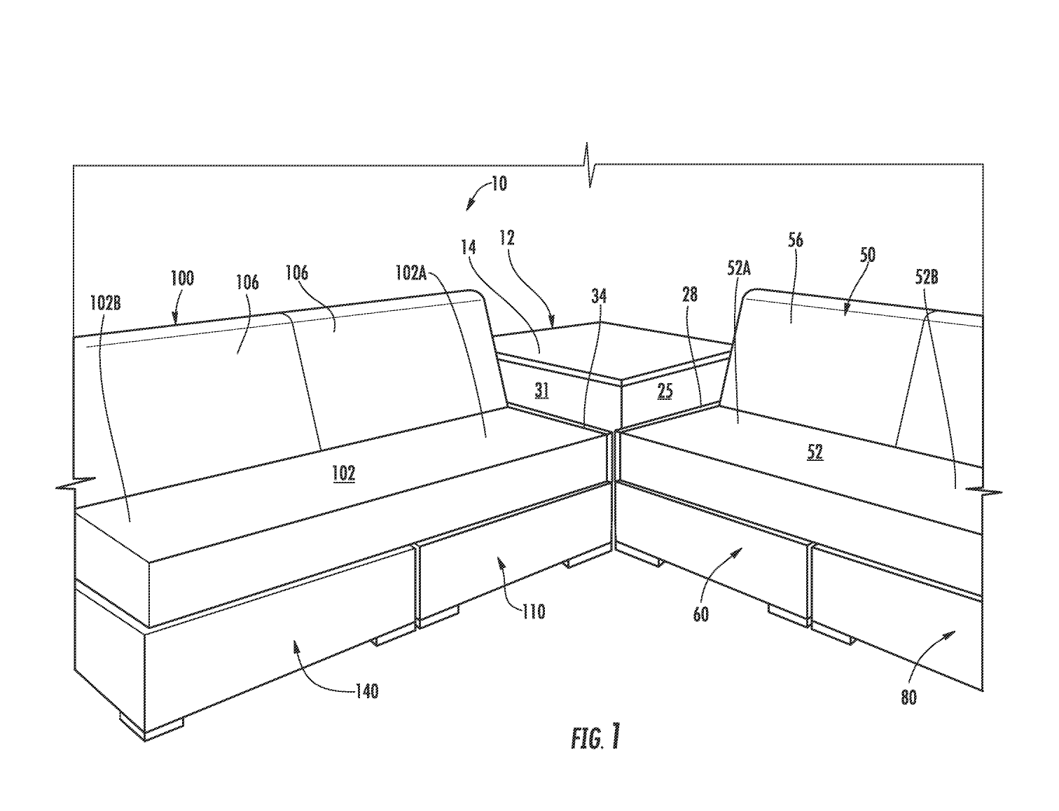

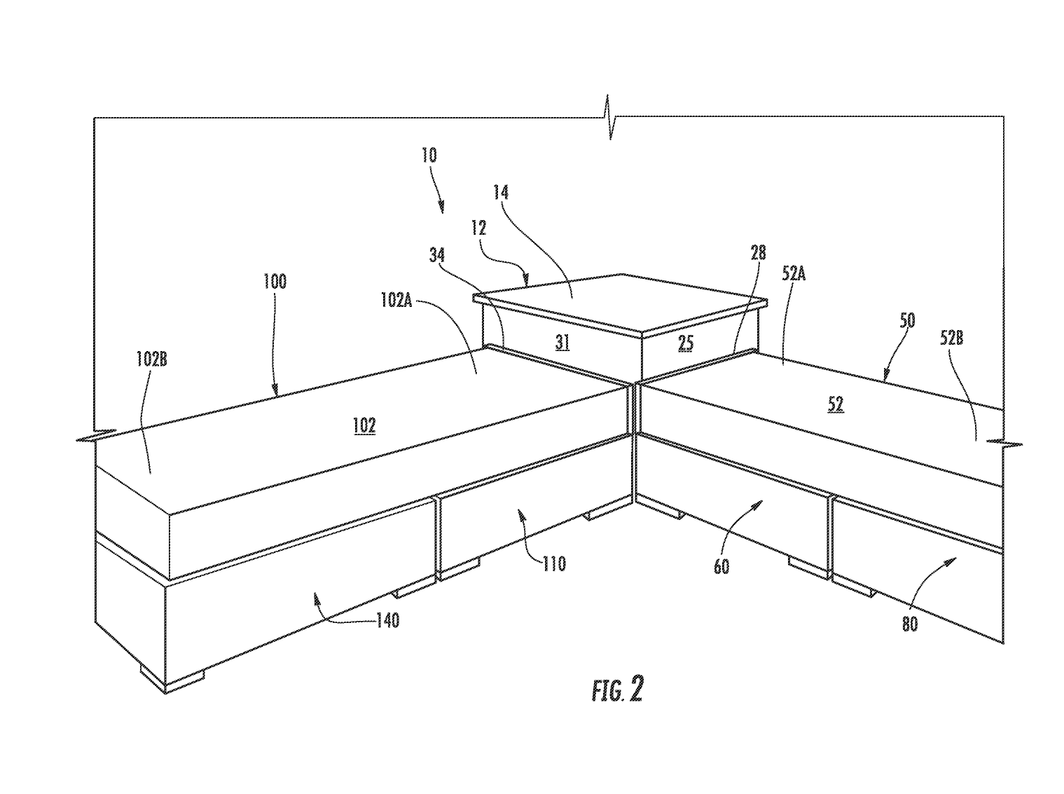

Referring to FIGS. 1 and 2, a furniture assembly or sofa bed of the present invention, generally indicated by reference number 10 is shown. Furniture assembly or sofa bed 10 can include a table 12 and first and second sofa bed sections 50 and 100 that extend away from table 12. Table 12 may have a variety of different shapes and sizes. For example, in FIG. 1, table 12 is shown as having a cube shape that allows table 12 to fit into a room corner as shown.

First sofa bed section 50 can have platforms, bases or frames 60 and 80, a cushion or mattress 52 and backrests 56. Bases or frames 60 and 80 are generally square or rectangular in shape. Other shapes may be used. Frame 80 can be individually moved away from frame 60. Mattress 52 can rest on frames 60 and 80. Cushion or mattress 52 can be a single unit that extends over frames 60 and 80 or can be two separate pieces with each cushion or mattress resting on an individual frame 60 or 80. Mattress 52 has ends 52A and 52B. Mattress end 52A is located adjacent to table 12. Mattress 52 may be any type of mattress or cushion that provides a comfortable surface upon which a person may sit or lay. Mattress 52 may be removed from frames 60 and 80 for transportation or cleaning Backrests 56 may sit or rest on mattress 52 and further be supported on one side by a wall of a room. Backrests 56 may be any type of cushion that provides comfortable back support. Backrest 56 may be removed, as shown in FIG. 2, when converting sofa bed 10 from a sofa into a bed.

Second sofa bed section 100 can have platforms, bases or frames 110 and 140, a cushion or mattress 102 and backrests 106. Bases or frames 110 and 140 are generally square or rectangular in shape. Other shapes may be used. Frame 140 can be individually moved away from frame 110. Mattress 102 can rest on frames 110 and 140. Cushion or mattress 102 can be a single unit that extends over frames 110 and 140 or can be two separate pieces with each cushion or mattress resting on an individual frame 110 or 140. Mattress 102 has ends 102A and 102B. Mattress end 102A is located adjacent to table 12. Mattress 102 may be any type of mattress or cushion that provides a comfortable surface upon which a person may sit or lay. Mattress 102 may be removed from frames 110 and 140 for transportation or cleaning Backrests 106 may sit or rest on mattress 102 and further be supported on one side by a wall of a room. Backrests 106 may be any type of cushion that provides comfortable back support. Backrests 106 may be removed, as shown in FIG. 2, when converting sofa bed 10 from a sofa into a bed.

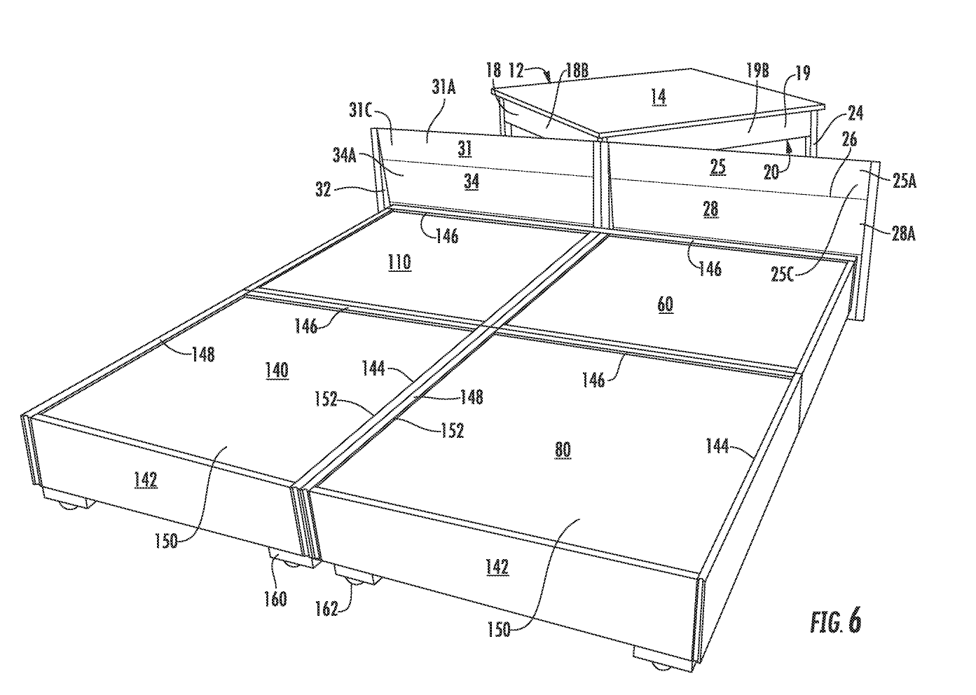

With reference to FIGS. 6, 7 and 8, table 12 may comprise a generally planar top surface 14, four generally planar side panels 16, 17, 18 and 19 and legs 24. Legs 24 and side panels 16, 17, 18 and 19 have a generally perpendicular relationship to top surface 14. Side panels 16, 17, 18 and 19 and top surface 14 define a hollow interior area 20. Side panel 16 can have an interior surface 16A and an exterior surface 16B. Side panel 17 can have an interior surface 17A and an exterior surface 17B. Side panel 18 can have an interior surface 18A and an exterior surface 18B. Side panel 19 can have an interior surface 19A and an exterior surface 19B. Table 12 may be formed from any suitable material such as wood, metal, plastic, composite or a combination of these materials. Legs 24 may be attached to top surface 12 by any suitable means such as using glue and fasteners. Similarly, side panels 16, 17, 18 and 19 may be attached to top surface 14 by any suitable means such as using glue and fasteners.

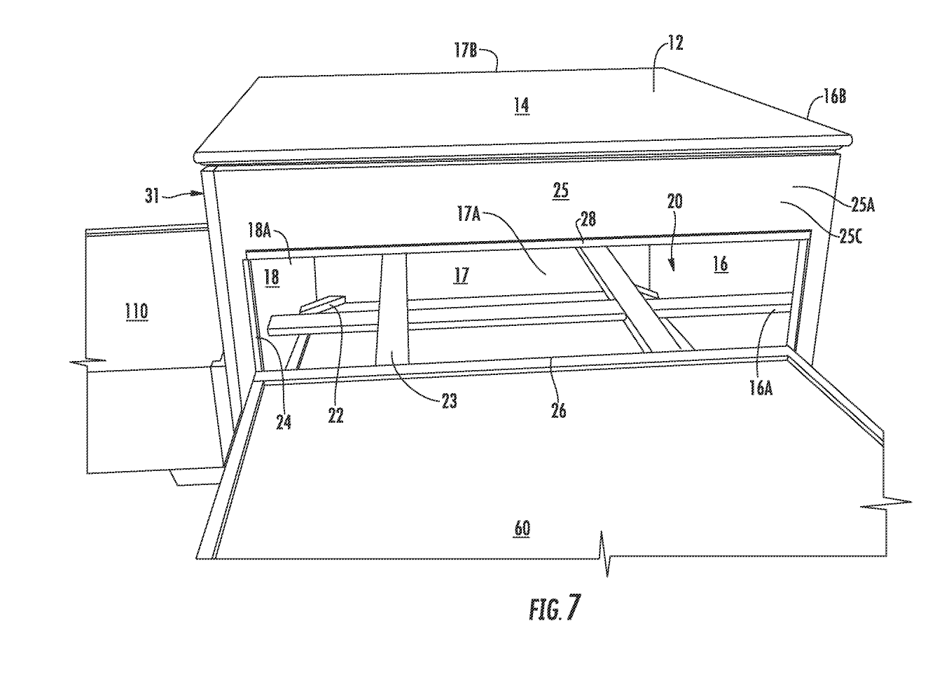

With specific reference to FIG. 7, a triangular shaped corner brace 22 may be added to each interior corner of table 12 to provide additional rigidity. Corner brace 22 may be attached to side panels 16, 17, 18 and 19 by using glue and fasteners. Several elongated mattress supports 23 can extend across interior area 20. A pair of mattress supports 23 can extend between and be connected to interior surfaces 17A and 19A. Another pair of mattress supports 23 can extend between and be connected to interior surfaces 16A and 18A.

Turning to FIGS. 6, 7 and 8, a pair of generally planar headboards 25 and 31 can be pivotally attached to table 12. Headboards 25 and 31 have a generally perpendicular relationship to top surface 14 and are parallel with and adjacent to side panels 18 and 19. Headboard 25 can have an upper portion 25A, lower portion 25B, front surface 25C, back surface 25D, opening 26, cover 28, cover front surface 28A and cover back surface 28B. Opening 26 extends perpendicularly through headboard 25 and provides a passage into interior area 20. Cover 28 may be mounted to headboard 25 using hinge 36. Hinge 36 can be attached to back surface 28B and back surface 25D using fasteners such as screws 37. Cover 28 can pivot inwardly about hinge 36 towards interior area 20. When cover 28 is in a closed position, the headboard front surface 25C is flush with cover front surface 28A. In one embodiment, cover 28 may be biased toward a closed position by a spring (not shown).

Headboard 31 can have an upper portion 31A (FIG. 6), lower portion 31B, front surface 31C (FIG. 6), back surface 31D, opening 32, cover 34, cover front surface 34A and cover back surface 34B. Opening 32 extends perpendicularly through headboard 31 and provides a passage into interior area 20. Cover 34 may be mounted to headboard 31 using another hinge (not shown). Similarly, the hinge can be attached to back surface 34B and back surface 31D using fasteners such as screws. Cover 34 can pivot inwardly about the hinge towards interior area 20. When cover 34 is in a closed position, the headboard front surface 31C is flush with cover front surface 34A. In one embodiment, cover 34 may be biased toward a closed position by a spring (not shown).

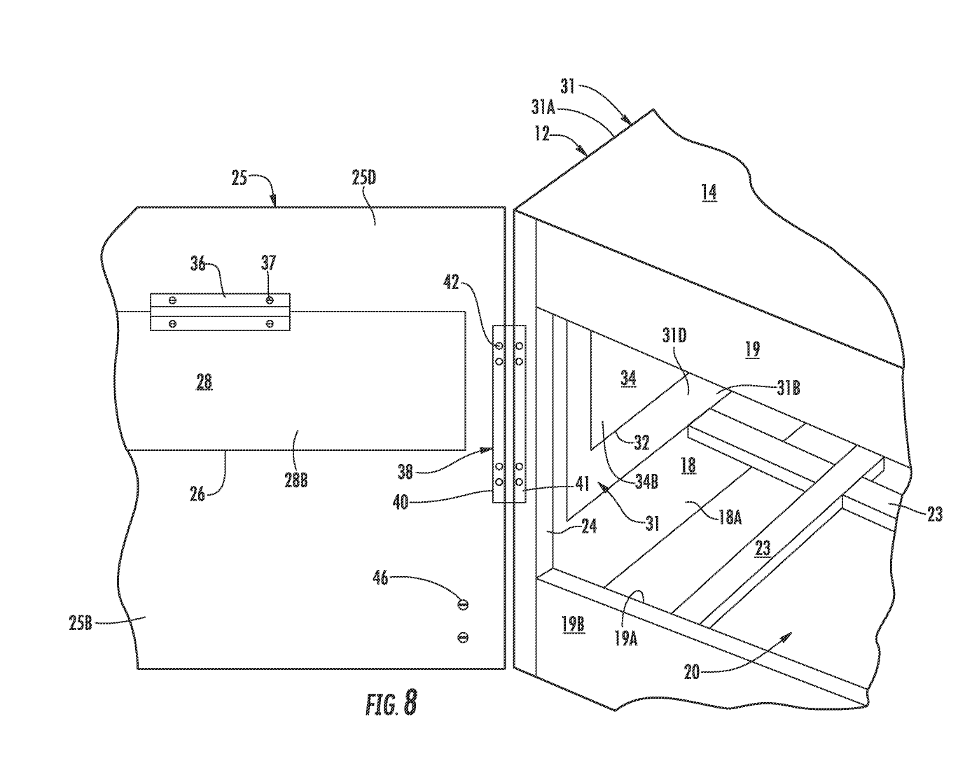

As shown in FIG. 8, a pivot member 38 can have a pair of outwardly extending flanges 40 and 41. Pivot member 38 can be any suitable mechanism such as a hinge that allows for rotation of headboard 25 relative to table 12. Another pivot member (not shown) may be used to rotatably attach headboard 31 to table 12. Alternatively, pivot member 38 may be a multi-flanged hinge that attaches to leg 24, headboard 25 and headboard 31. Flanges 40 and 41 can be attached to headboard 25 and leg 24, respectively using fasteners such as screws 42.

Turning now to FIG. 6, platforms, bases or frames 60, 80, 110 and 140 are generally cube shaped and each comprise four sides or rails 142, 144, 146 and 148, a planar recessed top 150, four feet 160 and four casters 162. Sides 142 are 146 are parallel and opposed. Sides 144 and 148 are parallel and opposed. Sides 142, 144, 146 and 148 can be fastened together using fasteners to form a generally square or rectangular shape. Planar top surface 150 can extend perpendicularly between sides 142, 144, 146 and 148. Top surface 150 can be recessed below the top edge of sides 142, 144, 146 and 148 such that a lip 152 is formed. Frames 60, 80, 110 and 140 can be formed from any suitable material such as wood, metal, plastic, composite or a combination of these materials. Feet 160 are mounted to each corner of the frames. Feet 160 extend downwardly from the frames and rest on a floor. Feet 160 support frames 60, 80, 110 and 140 such that the frames are raised slightly off from an underlying floor. Casters 162 can be recessed into each of feet 160. Casters 162 allow each of the frames to be easily rolled into an appropriate position.

Frame 60 can be affixed or attached to headboard 25 and frame 110 can be attached to headboard 31. Side 146 of frame 60 is adjacent headboard front surface 25C and is attached using a fastener 46 (FIG. 8). Side 146 of frame 110 is adjacent headboard front surface 31C and is attached using a fastener 46 (FIG. 8).

In an embodiment, frames 60, 80, 110 and 140 may be hollow and be configured to have one or more storage compartments (not shown). In another embodiment, frames 60, 80, 110 and 140 may be constructed similar to a box spring or may be made from a foam material.

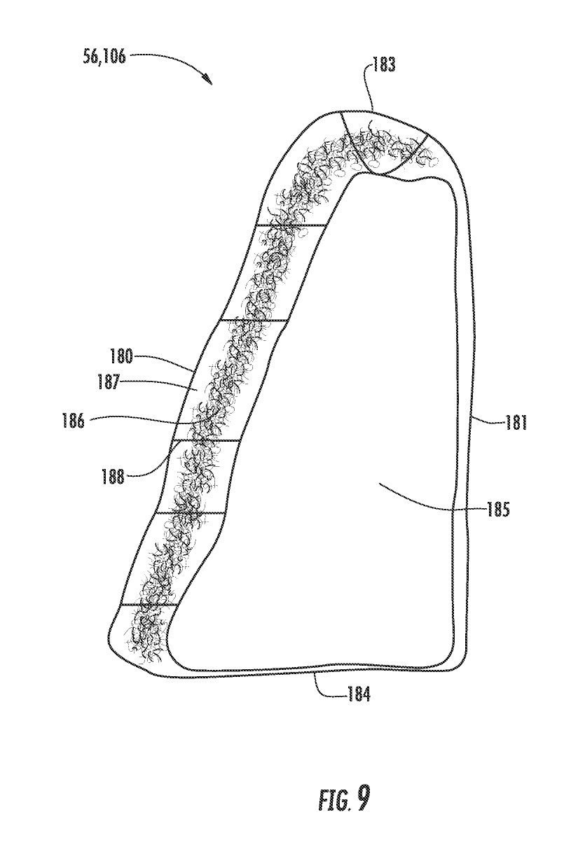

Turning now to FIG. 9, a cross-sectional view of backrests 56 and 106 is shown. Backrests 56 and 106 can be generally triangular in shape and have a front side 180, back side 181, top 183 and bottom 184. A foam material 185 can be located within back rests 56 and 106 and can be positioned towards back 181 and bottom 184. A soft filling material 186 such as feathers, cotton or shredded foam can be mounted over a portion of foam material 185 and sewn within several pockets or envelopes 187. Pockets or envelopes 187 may be defined by horizontally extending strips of material 188 that extend across the width of the backrests. In one embodiment, soft filling material 186 may be 10% down feathers and 90% goose or duck feathers. Soft filling material 186 may be located between foam material 185 and front side 180 and top 183. The use of soft filling material 186 can provide a more comfortable surface to rest on or lean against while foam material 185 provides needed support.

Referring to FIGS. 1-4, the operation of sofa bed 10 will now be described. In FIG. 1, sofa bed 10 is shown in a sofa configuration with backrests 56 and 106 resting on cushions or mattresses 52 and 102, respectively. A person may sit on the cushions or mattresses and recline on the backrests. In FIG. 2, the backrests 56 and 106 have been removed in preparation for conversion of sofa bed 10 into a bed configuration.

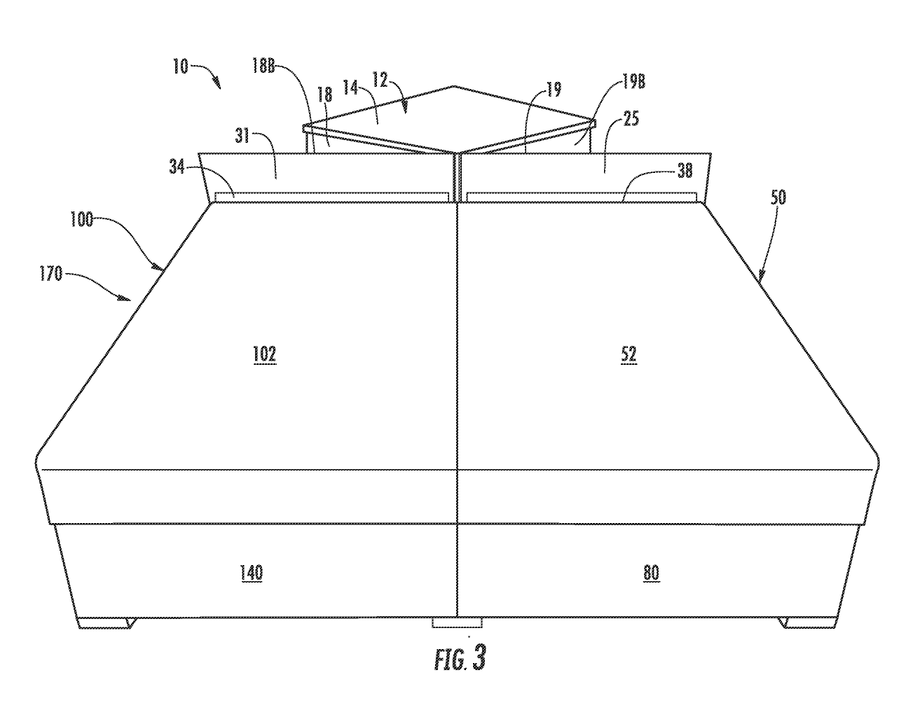

FIG. 3 shows sofa bed sections 50 and 100 after being rotated about table 12. Frames 60 and 110 are pivoted about pivot member 38 (FIG. 8). Frames 80 and 140 are rolled into position adjacent frames 60 and 110. Frames 60, 80, 110 and 140 roll on casters 162 (FIG. 6) when being slid along a floor. Sofa bed sections 50 and 100 are now adjacent each other with cushions or mattresses 52 and 102 in a side by side abutting relationship forming a bed 170. It is noted that headboard 25 pivots along with frame 60 and headboard 31 pivots with frame 110 to form double bed 170 such that headboards 25 and 31 are in position at the end of mattresses 52 and 102.

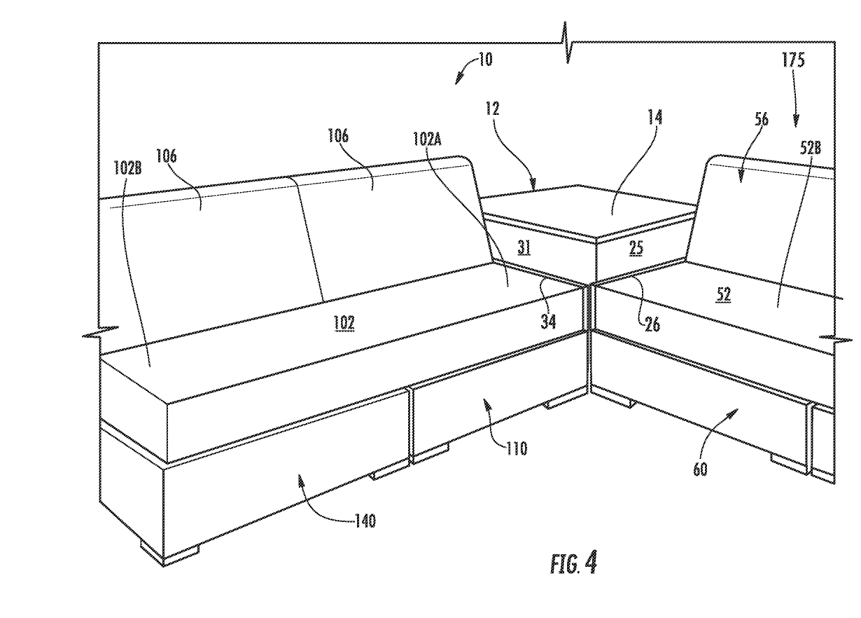

FIG. 4 shows sofa bed 10 in a compact shortened configuration 175. The configuration shown in FIG. 4 allows sofa bed 10 be used in rooms with shorter wall lengths or walls that include obstacles such as windows or doors. In FIG. 4, mattress 52 has been inserted through opening 26 into interior area 20 (FIG. 7) and frame 80 removed.

With reference to FIGS. 4, 7 and 8, a user may push on end 52B of mattress 52 towards table 12. As mattress 52 slides on frame 60, end 52A presses on cover 28 causing cover 28 to rotate about hinge 36 inwardly into interior area 20. As mattress 52 continues to slide, end 52A passes through opening 26 and onto mattress supports 23. Mattress 52 continues to slide into interior area 20 until end 52A contacts side panel interior surface 17A. This is the retracted position for mattress 52 and approximately ½ of mattress 52 is contained within table 20 and the other ½ rests on frame 60. Frame 80 can be removed and stored in another location. Backrest 56 can be placed on the exposed mattress end 52B to form a short or compact sofa 175.

In an alternative embodiment, mattress 52 may remain extended and mattress 102 be partially inserted into table 12 to form a short or compact sofa. Mattress 102 can be slid towards table 12 causing end 102A to press on cover 34 causing cover 34 to rotate about hinge 36 inwardly into interior area 20. As mattress 102 continues to slide, end 102A passes through opening 32 and onto mattress supports 23. Mattress 102 continues to slide into interior area 20 until end 102A contacts side panel interior surface 16A. This is the retracted position for mattress 102 and approximately ½ of mattress 102 is contained within table 20 and the other ½ rests on frame 110. Frame 140 can be removed and stored in another location.

### 1^{st} Alternative Embodiment

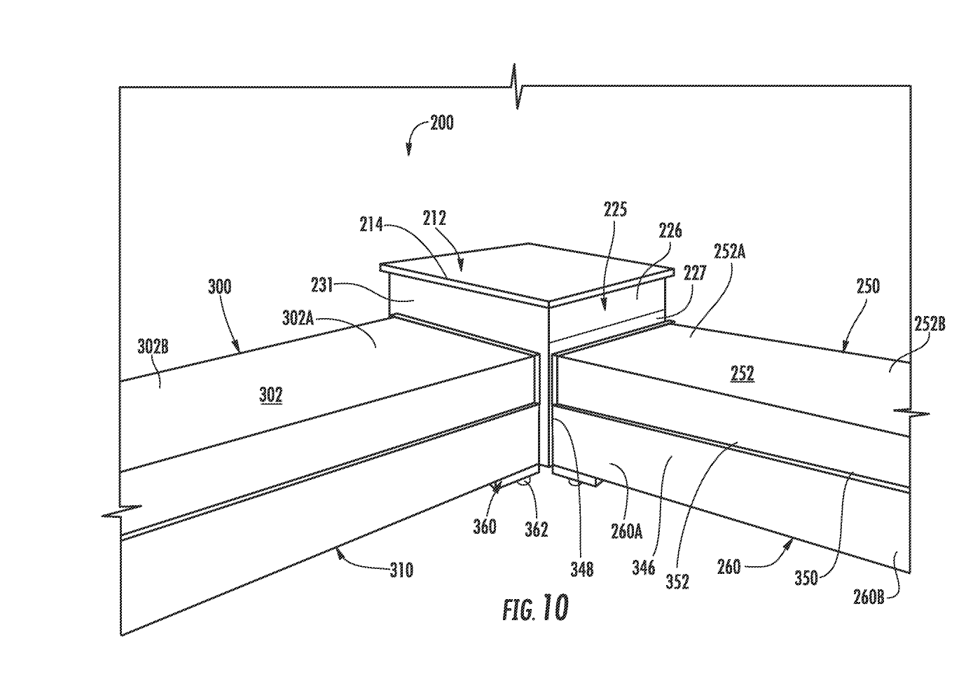

Referring to FIGS. 10, 11 and 12, another furniture assembly or sofa bed of the present invention, generally indicated by reference number 200 is shown. Furniture assembly or sofa bed 200 can include a table 212 and first and second sofa bed sections 250 and 300 that extend away from table 212. Frame 310 is pivotally connected to table 212 while frame 260 may be moved into or removed from table 212. Table 212 may have a variety of different shapes and sizes. For example, in FIG. 10, table 212 is shown as having a cube shape that allows table 212 to fit into a room corner as shown.

First sofa bed section 250 can have a frame 260 and a mattress 252. Backrests (not shown) may be placed on mattresses 252. Frame 260 can be generally rectangular in shape. Other shapes may be used. Mattress 252 can rest on frame 260. Mattress 252 has ends 252A and 252B. Mattress end 252A is located adjacent to table 212. Mattress 252 may be any type of mattress or cushion that provides a comfortable surface upon which a person may sit or lay. Mattress 252 may be removed from frame 260 for transportation or cleaning.

Second sofa bed section 300 can have a frame 310 and a mattress 302. Frame 310 can be generally rectangular in shape. Other shapes may be used. Mattress 302 can rest on frame 310. Mattress 302 has ends 302A and 302B. Mattress end 302A is located adjacent to table 212. Mattress 302 may be any type of mattress or cushion that provides a comfortable surface upon which a person may sit or lay. Mattress 302 may be removed from frame 310 for transportation or cleaning.

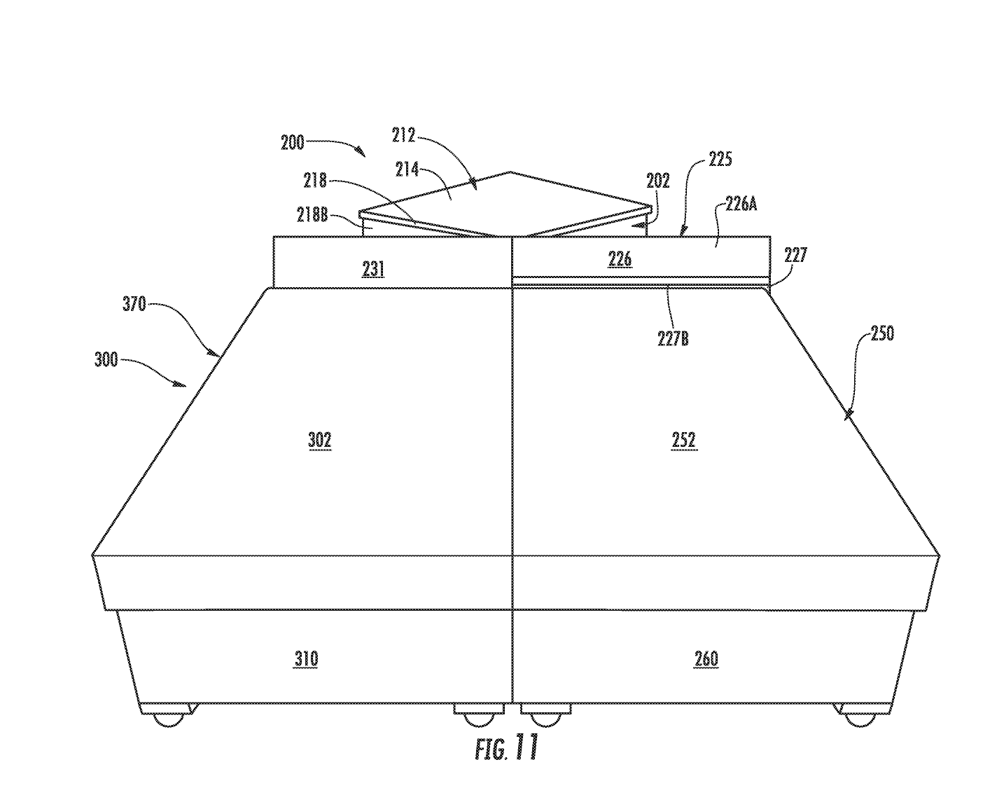

With reference to FIGS. 11, 12 and 13, table 212 may comprise a generally planar top surface 214, three generally planar side panels 216, 217 and legs 224. Legs 224 and side panels 216, 217 and 218 have a generally perpendicular relationship to top surface 214. Side panels 216, 217, 218 and top surface 214 define a hollow interior area 202 and an opening 204. Side panel 216 can have an interior surface 216A and an exterior surface 216B. Side panel 217 can have an interior surface 217A and an exterior surface 217B. Side panel 218 can have an interior surface 218A and an exterior surface 218B. Table 212 may be formed from any suitable material such as wood, metal, plastic, composite or a combination of these materials. Legs 224 may be attached to top surface 214 by any suitable means such as using glue and fasteners. Similarly, side panels 216, 217 and 218 may be attached to top surface 214 by any suitable means such as using glue and fasteners.

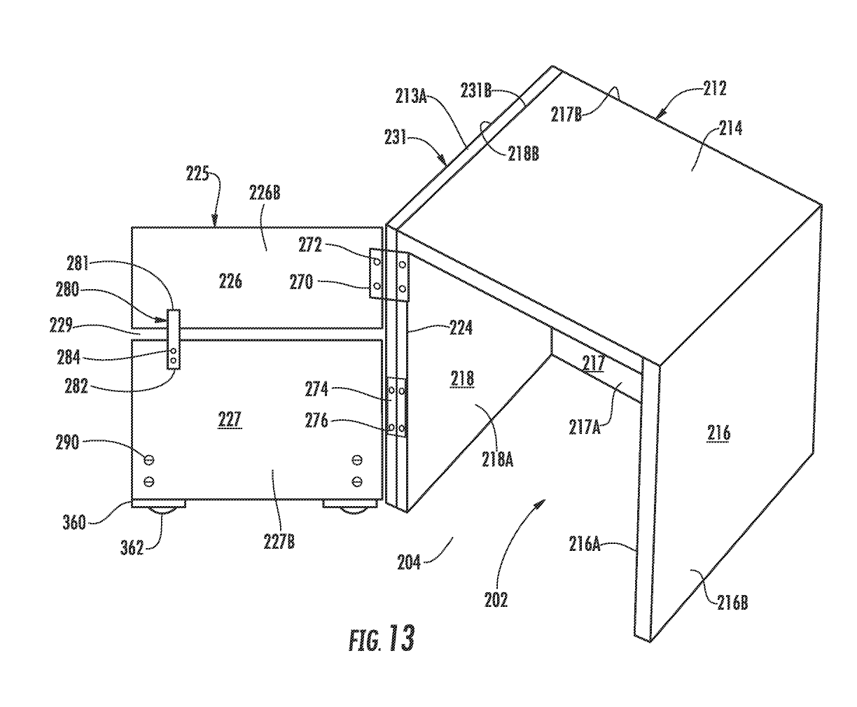

A generally planar headboard 231 can be pivotally attached to table 212. Headboard 231 has generally parallel relationship with adjacent side panels 218. Headboard 231 can have a front surface 231A and back surface 231B. As shown in FIG. 13, a pivot member 274 can be mounted between headboard 231 and a leg 224. Pivot member 274 can be any suitable mechanism such as a hinge that allows for rotation of headboard 231 relative to table 12. Pivot member 274 can be attached to headboard 231 and leg 224, respectively using fasteners such as screws 276. Pivot member 274 allows headboard 231 to rotate away from side panel 218 when frame 310 is rotated.

Headboard 225 can have an upper portion 226 that is pivotally attached to table 212 and a lower portion 227 that is connected to frame 260. Upper portion 226 is positioned above lower portion 227. A gap or space 229 is located between upper portion 226 and lower portion 227. Upper portion 226 can have a front surface 226A and a back surface 226B. Pivot member 270 can be mounted between headboard upper portion 226 and a leg 224. Pivot member 270 can be any suitable mechanism such as a hinge that allows for rotation of upper portion 226 relative to table 212. Pivot member 270 can be attached to headboard upper portion 226 and leg 224, respectively using fasteners such as screws 272. Pivot member 270 allows headboard upper portion 226 to rotate away from table 212 when frame 310 pulled outwardly from interior area 202.

Headboard lower portion 227 is connected to frame 260 using fasteners 290 (FIG. 13). A latch tab or locking tab 280 is removably coupled between upper portion 226 and lower portion 227. Latch tab 280 can have an upper end 281 and a lower end 282. Lower end 282 is connected to back side 227B using fasteners 284 such as screws. Upper end 281 can extend across gap 229 and engage and apply force to back side 226B. Latch tab 280 allows headboard upper portion 226 to move and rotate with headboard lower portion 227 when frame 260 is pulled outwardly from interior area 202. In one embodiment, latch tab 280 may be selectively locked into engagement with back side 226B or unlocked.

Turning now to FIGS. 10, 11 and 12, frames 260 and 310 are generally rectangular in shape and each comprise four sides or rails 342, 344, 346 and 348, a planar recessed top 350, four feet 360 and four casters 362. Sides 342 are 346 are parallel and opposed. Sides 344 and 348 are parallel and opposed. Sides 342, 344, 346 and 348 can be fastened together using fasteners to form a rectangular or square shape. Planar top surface 350 can extend perpendicularly between sides 342, 344, 346 and 348. Top surface 350 can be recessed below the top edge of sides 342, 344, 346 and 348 such that a lip 352 is formed. Frames 260 and 310 can be formed from any suitable material such as wood, metal, plastic, composite or a combination of these materials. Feet 360 are mounted to each corner of the frames. Feet 360 extend downwardly from the frames and rest on a floor. Feet 360 support frames 260 and 310 such that the frames are raised slightly off from an underlying floor. Casters 362 can be recessed into each of feet 360. Casters 362 allow each of the frames to be easily rolled into an appropriate position.

Frame 260 can be affixed or attached to lower headboard portion 227. Side 348 of frame 260 can be adjacent lower headboard portion 227 and attached using a fastener 290 (FIG. 13) such as screws or bolts. Similarly side 348 of frame 260 is adjacent headboard 231 and is attached using a fastener (not shown).

In an embodiment, frames 260 and 310 may be hollow and be configured to have one or more storage compartments (not shown). In another embodiment, frames 260 and 310 may be constructed similar to a box spring or may be made from a foam material.

Referring to FIGS. 10-13, the operation of sofa bed 200 will now be described. In FIG. 10, sofa bed 200 is shown in a sofa configuration. A person may sit on mattresses 252 and 302 and recline on the backrests (not shown).

FIG. 11 illustrates sofa bed sections 250 and 300 after being rotated about table 212. Frame 260 is pivoted about pivot member 270 (FIG. 13). Frame 310 is pivoted about pivot member 274 (FIG. 13). Frames 260 and 310 roll on casters 362 when being slid along a floor. Sofa bed sections 250 and 300 are now adjacent each other with mattresses 252 and 302 in a side by side abutting relationship forming a bed 370. It is noted that headboard 225 pivots along with frame 260 and headboard 231 pivots with frame 310 to form bed 370 such that headboards 225 and 231 are in position at the end of mattresses 252 and 302.

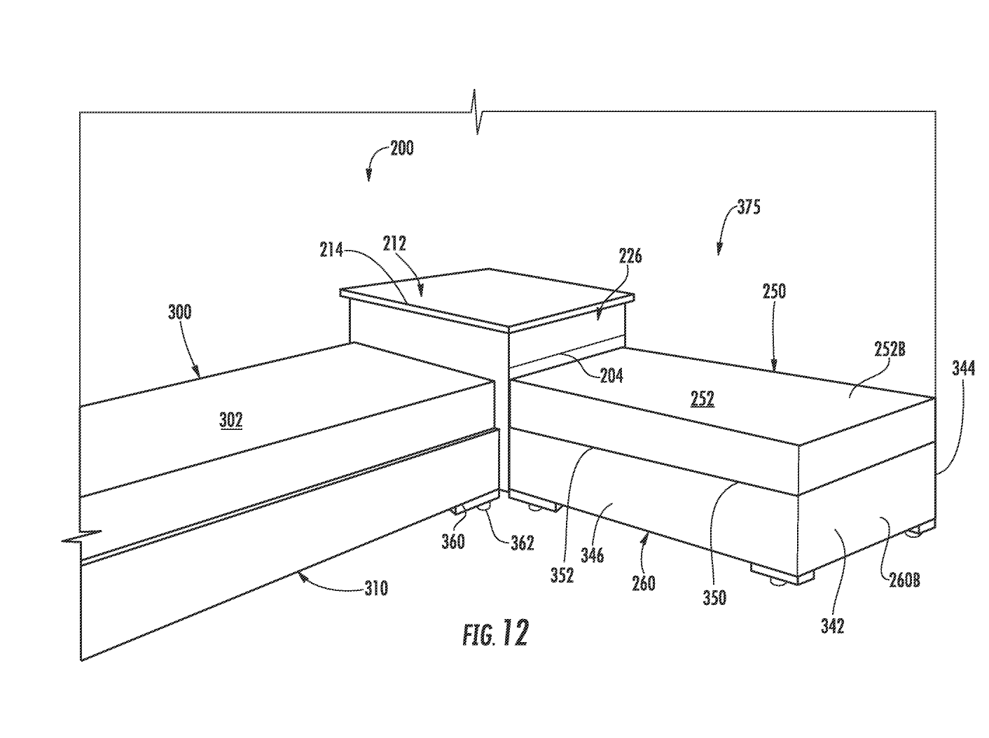

FIG. 12 shows sofa bed 200 in a compact shortened configuration 375. The configuration shown in FIG. 12 allows sofa bed 200 be used in rooms with shorter wall lengths. In FIG. 12, mattress frame 260 and mattress 252 have been inserted through opening 204 into interior area 202 (FIG. 13).

With reference to FIG. 10, a user may push on frame end 260B causing frame 260 to roll or slide towards table 212. Frame 260 and lower headboard portion 227 move through opening 204 into interior area 202 (FIG. 13). At the same time, upper headboard portion 226 may abut top 214 and side panel 216 causing upper headboard portion 226 to remain in a closed position. Frame 260 and mattress 252 continues to slide into interior area 202 until end upper headboard portion 226 contacts side panel interior surface 217A as shown in FIG. 12. This is the retracted position for sofa bed 250 and approximately ½ of frame 260 and mattress 252 is contained within table 212 and the other ½ is located outside of table 212.

With reference to FIGS. 12 and 13, a user may pull on frame end 260B causing frame 260 to roll or slide outwardly from table 212. Frame 260 and lower headboard portion 227 move through opening 204 out from interior area 202. Frame 260 and mattress 252 continues to slide outwardly until latch tab end 281 engages or contacts the back side 226B of upper headboard portion 226. Further pulling on frame 260 causes latch tab end 281 to cause upper headboard portion 226 to rotate about pivot member 270. Thereby, when frame 260 is moved into the bed configuration of FIG. 11, upper headboard portion 226 and lower headboard portion 227 are coplanar forming a unitary headboard 225.

### 2nd Alternative Embodiment

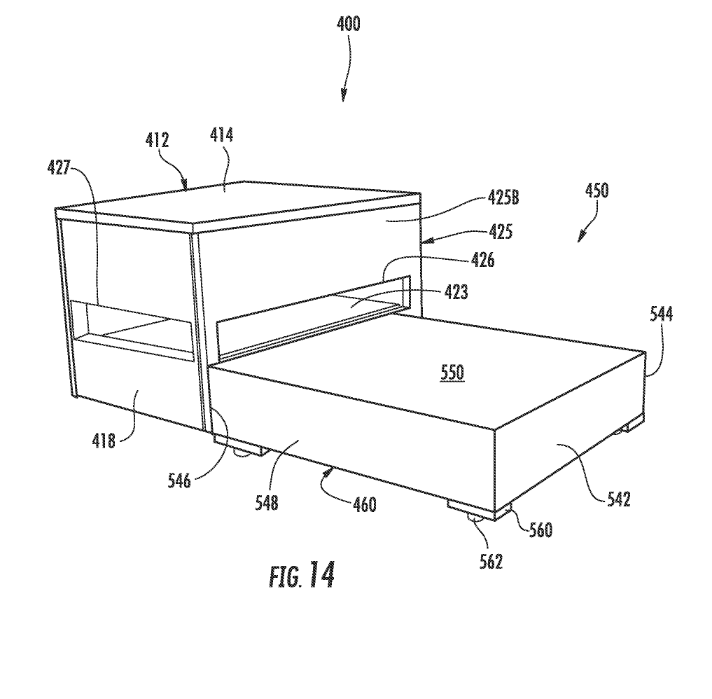

Referring to FIGS. 14, 15 and 16, a furniture assembly or sofa bed of the present invention, generally indicated by reference number 400 is shown. In FIGS. 14-16, the mattresses and backrests have been omitted. Furniture assembly or sofa bed 400 can include a table 412 and sofa bed section 450 that extends away from table 412. Additional sofa bed sections may be added if desired. Table 412 may have a variety of different shapes and sizes.

Table 412 may comprise a generally planar top surface 414, generally planar side panels 416 and 417 and removable headboards 418 and 425. Side panels 416, 417, and headboards 418 and 425 have a generally perpendicular relationship to top surface 414. Side panels 416, 417, headboards 418, 425 and top surface 414 define a hollow interior area 420. Side panel 416 can have an interior surface 416A and an exterior surface 416B. Side panel 417 can have an interior surface 417A and an exterior surface 417B. Headboard 418 can have an interior surface 418A and an exterior surface 418B. Headboard 425 can have an interior surface 425A and an exterior surface 425B. Table 412 may be formed from any suitable material such as wood, metal, plastic, composite or a combination of these materials. Side panels 416, 417 may be attached to top surface 414 by any suitable means such as using glue and fasteners. A planar mattress support 423 can extend across interior area 420. Mattress support 423 may extend between interior surfaces 416A and 418A.

Headboard 418 can have a rectangular shaped opening 427 that is adapted to receive a mattress. Headboard 425 can have a rectangular shaped opening 426 that is adapted to receive a mattress. Headboards 418 and 425 have a generally perpendicular relationship to top surface 414. Headboards 418 and 425 are configured to be individually removable from table 412.

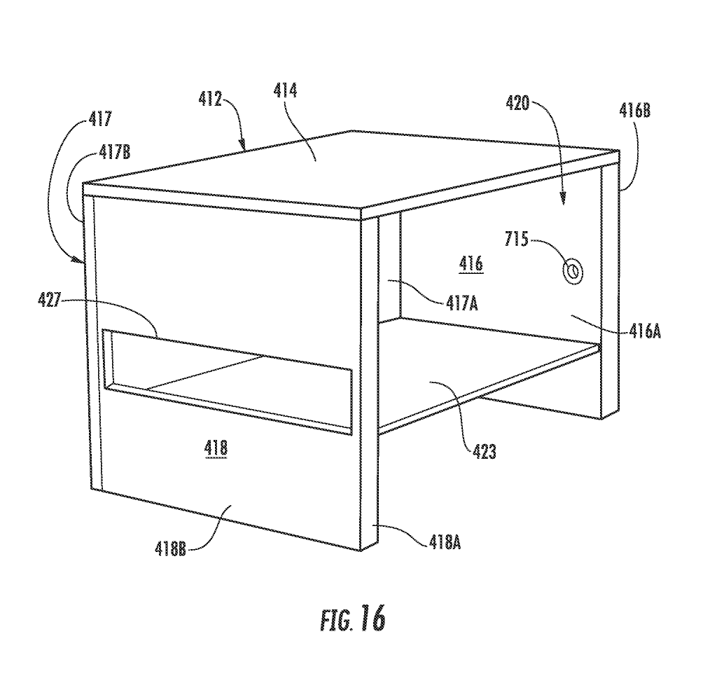

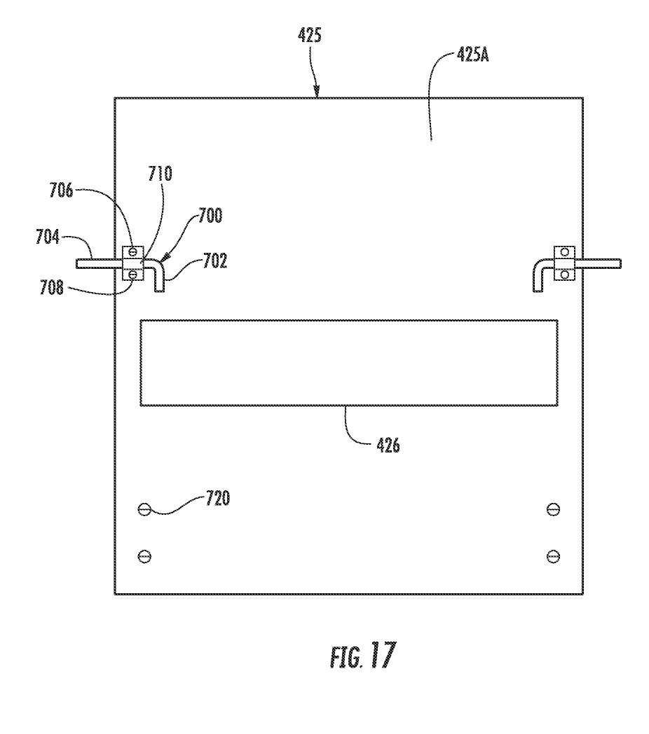

Headboard 425 can have an opening 426 that extends perpendicularly through headboard 425 and provides a passage into interior area 420. With reference to FIG. 17, a pair of connector mechanisms or spring loaded pin mechanisms 700 can be attached to surface 425A using fasteners such as screws 708. Pin mechanism 700 comprises a handle 702, pin end 704, bracket 706 and spring 710. Pin ends 704 can extend into bores 715 (FIG. 16) that are located on interior surfaces 416A and 418A. Spring 710 can bias pin end 704 into bore 715 causing the retention of headboard 425 to table 412. When handles 702 are pulled, pin ends 704 slide out of bores 715 allowing headboard 425 to be released or removed from table 412.

Headboard 418 can have an opening 427 that extends perpendicularly through headboard 418 and provides a passage into interior area 420. Spring loaded pin mechanisms 700 may also be attached to surface 418A such that headboard 418 is removable from table 412

Turning back to FIGS. 14-16, frames 460 and 480 are generally square in shape and each comprise four sides or rails 542, 544, 546 and 548, a planar recessed top 550, four feet 560 and four casters 562. Sides 542 are 546 are parallel and opposed. Sides 544 and 548 are parallel and opposed. Sides 542, 544, 546 and 548 can be fastened together using fasteners to form a generally square or rectangular shape. Planar top surface 550 can extend perpendicularly between sides 542, 544, 546 and 548. Top surface 550 can be recessed below the top edge of sides 542, 544, 546 and 548 such that a lip is formed. Frames 460 and 480 can be formed from any suitable material such as wood, metal, plastic, composite or combination of these materials. Feet 560 are mounted to each corner of the frames. Feet 560 extend downwardly from the frames and rest on a floor. Feet 560 support frames 460 and 480 such that the frames are raised slightly off from an underlying floor. Casters 562 can be recessed into each of feet 560. Casters 562 allow each of the frames to be easily rolled into an appropriate position.

Frame 460 can be affixed or attached to headboard 425. Side 546 is adjacent headboard surface 425B and is attached using a fastener 720 (FIG. 17).

Referring to FIG. 14, the operation of sofa bed 400 will now be described. In FIG. 14, sofa bed 400 is shown in a shortened sofa configuration with only one frame 460 being used with table 412. In FIG. 14, a mattress (not shown) would rest partially on mattress support 423 within table 412 and partially on top surface 550. A person may sit on the mattress and recline on the backrest (not shown). A mattress may be moved in or out of opening 426. Alternatively, a mattress may be moved in or out of opening 427.

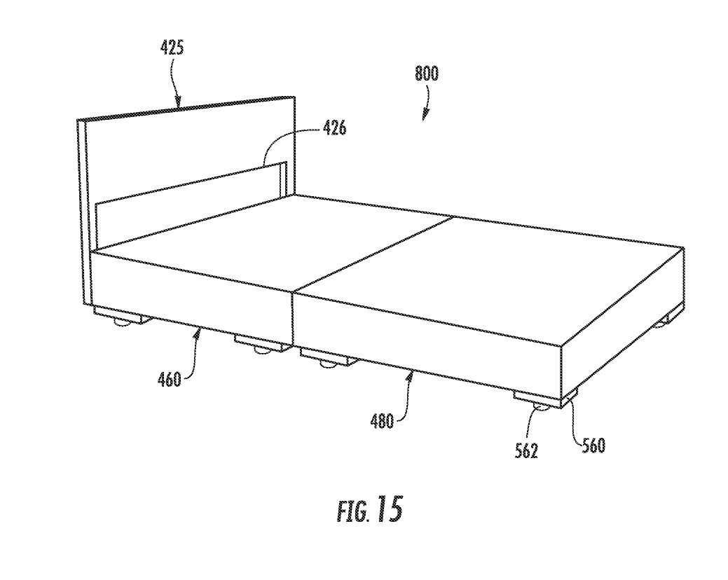

FIG. 15 shows sofa bed 400 after conversion into a bed 800. Headboard 425 has been removed from table 412 by pulling on handles 702 (FIG. 17) and separating headboard 425 from table 412. Frames 480 have been rolled adjacent and in an abutting relationship to frame 460. A mattress may now be placed on frames 460 and 480 to complete bed 800.

Headboard 418 (FIG. 14) may also be removed from table 412 (FIG. 14). Headboards 418 and 425 may then be moved into an adjacent side by side configuration allowing the formation of a bed such as similarly illustrated in FIG. 3, when additional frames and mattresses are added.

FIG. 16 shows what table 412 looks like after headboard 425 has been removed from table 412 to form bed 800.

### 3rd Alternative Embodiment

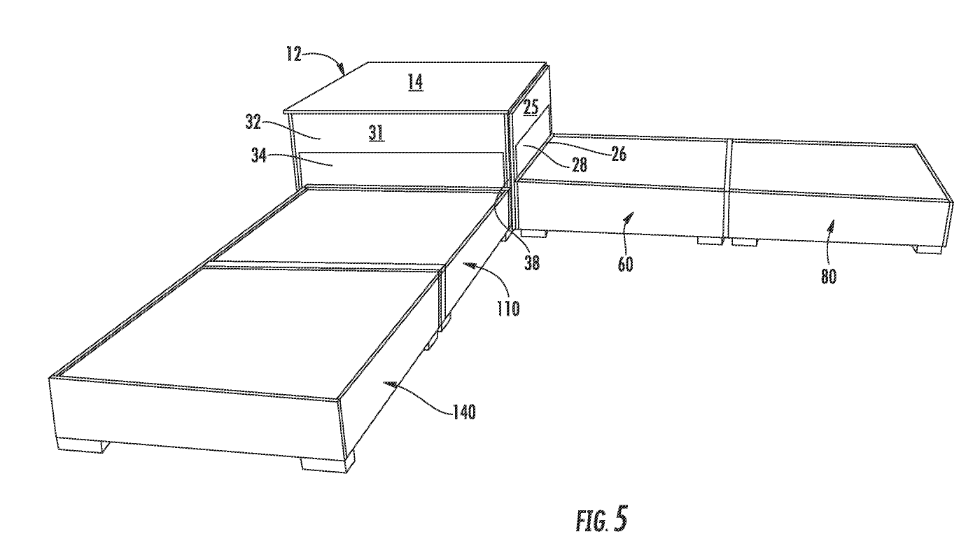

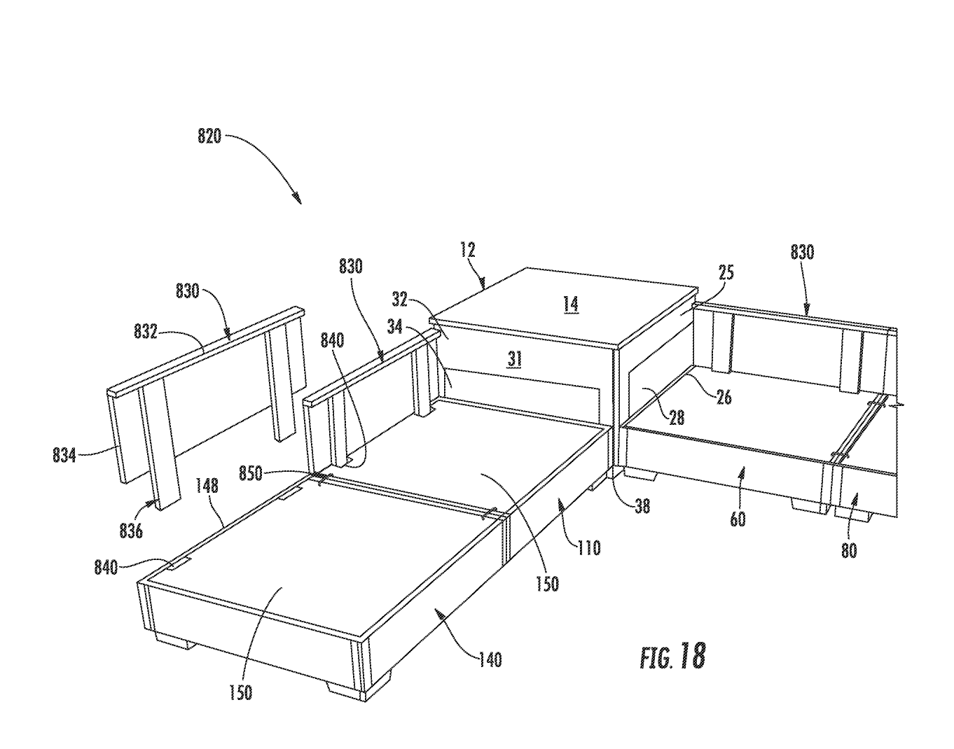

Referring to FIG. 18 a furniture assembly or sofa bed of the present invention, generally indicated by reference number 820 is shown. In FIG. 18, the mattresses, cushions and backrests have been omitted for clarity. Furniture assembly or sofa bed 820 can include a table 12 and platforms or frames 60, 80 and 110, 140 that extends away from table 12. Sofa bed 820 is similar to sofa bed 10 previously described in FIGS. 1-8, except that backrest 830 have been added so that sofa bed 820 may be used in a room or location where a wall is not available to support a back rest cushion. Two rectangular shaped stake holes 840 are located in framed top surface 150 adjacent to rail 148. Back rest 830 comprises a generally horizontally configured back rail, two spaced apart generally vertically stakes 836 and a back board 834 extending across the stakes and to the back rail. Stakes 836 can be inserted into stake holes 840 in order to mount back rest 830 to one of the platforms or frames, such as platform 140. Back rest 832 may be removed by lifting vertically upward on back rest 832 away from the platform allowing stakes 832 to slide out from stake holes 840. Back rest 830 allow for sofa bed 820 to support cushions where a wall is not available to support back rest cushions in a sofa configuration.

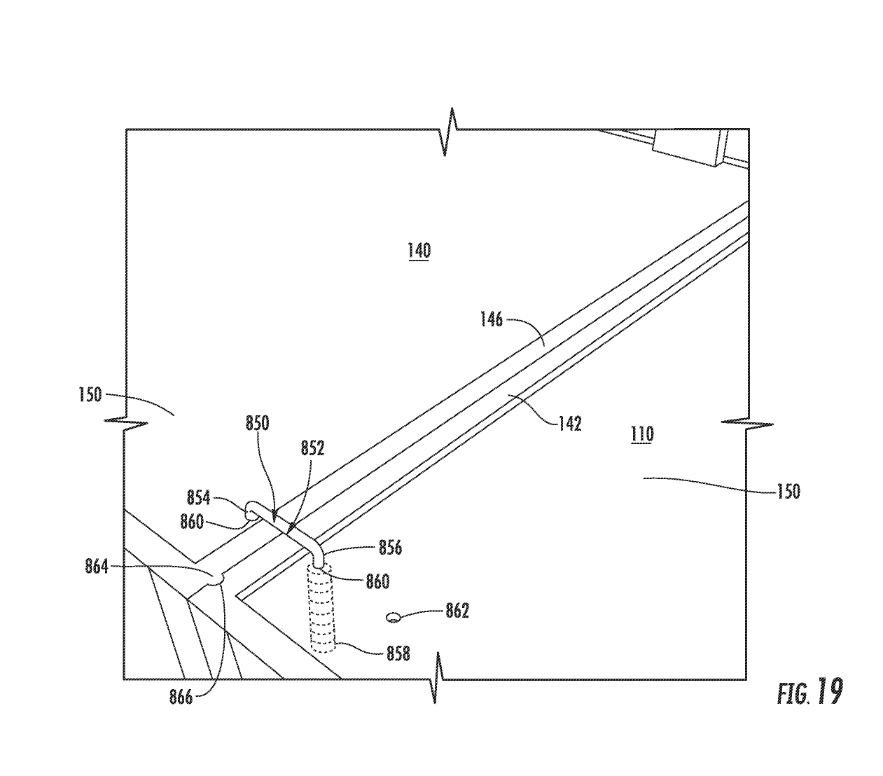

With additional reference to FIG. 19 the use and operation of U clips 850 will now be described. U clips 850 allow for the selective retention of various platforms or frames, 60, 80, 110 or 140 to each other as selected by the user. U clip 850 comprises a center section 852 and ends 854 and 856 that extends perpendicularly away from center section 852. A retention hole 860 can be located in top surface 150 of frames 110 and 140. A spring 858 is mounted in one of retention holes 860 and coupled to end 856. Spring 858 biases U clip 850 toward top surface 150. U clips 850 can span between frames 110 and 140 with one end 154 extending into retention hole 860 and the other end 856 retained in retention hole 860. In this manner, U shaped clips 850 are able to retain or hold frames 110 and 140 together. When not in use, U shape clips 850 may be stored by rotating the clip 850, such that end 854 is inserted into storage hole 862. Center section 854 may be pressed downwardly such that the center section is adjacent to top surface 150. The present invention allows the use of a convertible sofa bed in rooms that have short walls or walls that include obstacles such as windows or doors. The sofa bed of the present invention provides a headboard that moves with the bed when conversion from a sofa to a bed occurs. The sofa bed of the present invention allows for the partial storage of a mattress within a table.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

We claim:

1. A furniture assembly comprising:
(A) a table having a first and second headboard and an interior area;
(B) a first frame coupled to the first headboard;
(C) a second frame coupled to the second headboard;
(D) a pivot member coupled to the table and to the first and second headboards, the pivot member allowing the first and second headboards to rotate relative to the table;
(E) a first opening located in the first headboard; and
(F) a first mattress adapted to rest on the first frame, the first mattress movable from an extended position located outside the interior area to a retracted position wherein, at least a portion of the first mattress extends through the first opening into the interior area.

2. The furniture assembly of claim 1, further comprising a first cover coupled to the first headboard and positioned over the first opening, the first cover adapted to be moved from a closed position to an open position.

3. The furniture assembly of claim 1, further comprising a second opening located in the second headboard.

4. The furniture assembly of claim 3, further comprising a second cover coupled to the second headboard and positioned over the second opening, the second cover adapted to be moved from a closed position to an open position.

5. The furniture assembly claim 4, further comprising a second mattress adapted to rest on the second frame, the second mattress movable from an extended position located outside the interior area to a retracted position wherein at least a portion of the second mattress extends through the second opening into the interior area.

6. The furniture assembly of claim 1, wherein a plurality of casters are coupled to the first frame.

7. The furniture assembly of claim 1, wherein a third frame is positioned adjacent the first frame.

8. The furniture assembly of claim 1, wherein a first backrest is adapted to rest on the first mattress.

9. A furniture assembly comprising:
(A) a table having a first opening and an interior area;
(B) a first pivot member coupled to the table;
(C) a first upper headboard portion coupled to the pivot member, the first upper headboard portion being adapted to cover at least a portion of the first opening;
(D) a first frame having a first end and a second end;
(E) a first lower headboard portion connected to the first end of the first frame, the first frame and the first lower headboard portion adapted to be moved from a first position outside the table to a second position wherein the first lower headboard portion and at least a portion of the first frame extend through the first opening into the interior area;
(F) a second pivot member coupled to the table; and
(G) a second headboard coupled to the second pivot member.

10. The furniture assembly of claim 9, wherein a latch tab is connected to the first lower headboard portion and extends towards the first upper headboard portion, the latch tab adapted to engage the first upper headboard portion as the first frame is moved.

11. The furniture assembly of claim 10, wherein the latch tab has a first end and a second end, the first end connected to the first lower headboard portion and the second end engagable with the first upper headboard portion.

12. The furniture assembly of claim 9, further comprising a first mattress adapted to rest on the first frame.

13. The furniture assembly of claim 9, further comprising a second frame connected to the second headboard.

14. The furniture assembly claim 13, wherein the first frame, the first upper headboard portion, the first lower headboard portion, the second frame and the second headboard are adapted to rotate to form a double bed.

15. The furniture assembly of claim 9, wherein a plurality of casters are coupled to the first frame.

16. A furniture assembly comprising:
(A) a table having a top surface and defining an interior area;
(B) a first headboard coupled to a first side of the table, the first headboard having a first opening;
(C) a second headboard coupled to a second side of the table, the second headboard having a second opening;
(D) a first frame connected to the first headboard; and
(E) a first connector mechanism coupled between the first headboard and the table, the first connector mechanism allowing the first headboard to be selectively removed from the table.

17. The furniture assembly of claim 16, further comprising a mattress support connected to the table and extending across the interior area.

18. The furniture assembly of claim 17, further comprising a first mattress adapted to rest on the first frame.

19. The furniture assembly of claim 18, wherein the first mattress has a first end and a second end, the first end adapted to pass through the first opening and rest on the mattress support when the mattress is in a retracted position.

20. The furniture assembly of claim 16, further comprising a second connector mechanism coupled between the second headboard and the table, the second connector mechanism allowing the second headboard to be selectively removed from the table.
